(19) United States
(12) Patent Application Publication
(10) Pub. No.: US 2011/0084790 A1
(43) Pub. Date: Apr. 14, 2011

(54) NEUTRAL-GROUNDED STRUCTURE FOR DELTA-CONNECTED WINDINGS AND METHOD THEREOF

(76) Inventors: Tsai-Hsiang Chen, Taipei City (TW); I Chang, Taipei City (TW); Tai-Jou Chen, Taipei City (TW)

(21) Appl. No.: 12/577,733

(22) Filed: Oct. 13, 2009

(51) Int. Cl. H01F 27/28

(52) U.S. Cl. 336/170

(57) ABSTRACT

A neutral-grounded structure and a method for delta-connected windings are provided. The delta-connected windings include a first phase winding, a second phase winding, and a third phase winding. A grounding winding is disposed on at least one of the phase windings. The first end of the grounding winding is connected to a grounded point which is utilized as a neutral point. The second end of the grounding winding is connected to a tap of one of the other two phase windings. The voltage phase displacement between the grounding winding and the phase winding corresponding to the grounding winding is 180 degrees. According to the above-mentioned neutral-grounded structure, all the three phase-to-ground voltages are the same when the three phase voltages are balanced. Accordingly, the present invention can solve correlated problems due to differences of the three phase-to-ground voltages of delta-connected windings with conventional grounding methods.

### TECHNICAL FIELD OF THE INVENTION

The present invention relates to winding connection, and more particularly to a neutral-grounded structure for delta-connected windings and method thereof.

### BACKGROUD OF THE INVENTION

The connection methods of a three phase windings can be a delta-connected or a wye-connected. In comparison, the desired dielectric strength of the wye-connected windings is lower. However, the grounded wye-connected windings have defects of providing a path for zero-sequence current, third harmonic current, and 3× harmonic currents to pass through. Accordingly, the grounded wye-connected windings are unfavorable to efficiency and quality in a power distribution system. Although the delta-connected windings do not have the defects of providing a path for zero-sequence current and harmonic currents to pass through, the desired dielectric strength of the delta-connected windings is higher than that of the wye-connected windings. As a result, when the delta-connected windings and the wye-connected windings are applied in the same power distribution system, the dielectric strength of the delta-connected windings has to be higher than that of the wye-connected windings. The delta-connected windings are also called Δ-connected windings. Generally speaking, conventional grounding methods in the delta-connected windings include a line-grounded method and a mid-phase grounded method. The line-grounded method is also called a corner-grounded method. FIG. 1 illustrates a diagram of the line-grounded method in the delta-connected windings. In the line-grounded method, one corner of the delta-connected windings is grounded. A phase line c is drawn forth and grounded in FIG. 1. Accordingly, the voltage of the phase line c is in the ground potential, and the voltage between each of the other two phase lines and the grounded point n is a line voltage. FIG. 2 illustrates a diagram of the mid-phase grounded method in the delta-connected windings. In the mid-phase grounded method, a mid-tap in one of the delta-connected windings is drawn forth to a grounded point n. As shown in FIG. 2, the mid-tap is in the middle of the winding between the phase line a and the phase line c, and the mid-tap is drawn forth and connected to the grounded point n. As a result, the voltage between the phase line a and the grounded point n or between the phase line c and the grounded point n is half of the line voltage, and the voltage between the phase line b and the grounded point n is √3/2 times of the line voltage.

From the above-mentioned, the conventional grounding methods in the delta-connected windings lead to differences of the three phase-to-ground voltages. And many problems are thus derived. For example, when a coil of a contactor in a motor control circuit is connected to the improper phase lines of the delta-connected windings, the coil might be broken due to effects of grounded points in the conventional grounding methods.

### SUMMERY OF THE INVENTION

The primary objective of the present invention is to provide a neutral-grounded structure for delta-connected windings. The delta-connected windings include a first phase winding, a second phase winding, and a third phase winding. Each of the first phase winding, the second phase winding, and the third phase winding has a plurality of turns, e.g. N turns. A grounding winding is disposed on at least one of the first phase winding, the second phase winding, and the third phase winding. The grounding winding has turns that are (⅓)N turns of one of the phase windings. The first end of the grounding winding is connected to a grounded point which is utilized as a neutral point. The second end of the grounding winding is connected to a tap of one of the other two phase windings. The tap is at (⅓)N turns of one of the other two phase windings. The voltage phase displacement between the grounding winding and the phase winding corresponding to the grounding winding is 180 degrees.

Another objective of the present invention is to provide a neutral-grounded structure for delta-connected windings. The delta-connected windings include a first phase winding, a second phase winding, and a third phase winding. Each of the first phase winding, the second phase winding, and the third phase winding has a plurality of turns, e.g. N turns. A grounding winding group is disposed on at least one of the first phase winding, the second phase winding, and the third phase winding. The grounding winding group includes at least two grounding windings which are connected in parallel. Each of the grounding windings has turns that are (⅓)N turns of one of the phase windings. The first end of the grounding winding group is connected to a grounded point which is utilized as a neutral point. The second end of the grounding winding group is connected to a tap of one of the other two phase windings. The tap is at (⅓)N turns of one of the other two phase windings. The voltage phase displacement between the grounding winding group and the phase winding corresponding to the grounding winding is 180 degrees.

Another objective of the present invention is to provide a neutral-grounded method for delta-connected windings. The delta-connected windings include a first phase winding, a second phase winding, and a third phase winding. Each of the delta-connected windings has a plurality of turns, e.g. N turns. The neutral-grounded method includes the following steps. A grounding winding is disposed on at least one of the first phase winding, the second phase winding, and the third phase winding. The grounding winding has turns that are (⅓)N turns of one of the phase windings. The first end of the grounding winding is connected to a grounded point which is utilized as a neutral point. The second end of the grounding winding is connected to a tap of one of the other two phase windings. The tap is at (⅓)N turns of one of the other two phase windings. The voltage phase displacement between the grounding winding and the corresponding phase winding is 180 degrees.

According to the neutral-grounded structure for the delta-connected windings and method thereof, voltage differences between each of the phase line and the neutral point are the same. When a three-phase power is fed to the phase windings, the three phase-to-ground voltages are the same. As a result, problems of differences of the three phase-to-ground voltages can be solved.

### BRIEF DESCRIPTION OF THE DRAWINGS

FIG. 1 illustrates a diagram of the line-grounded method in the delta-connected windings;

FIG. 2 illustrates a diagram of the mid-phase grounded method in the delta-connected windings;

FIG. 3 illustrates a diagram of disposing one grounding winding on one phase winding according to a neutral-grounded structure for delta-connected windings of the present invention;

FIG. 4 illustrates a practical circuit according to the neutral-grounded structure in FIG. 3;

FIG. 5 illustrates a voltage phasor diagram corresponding to the neutral-grounded structure for the delta-connected windings in FIG. 3;

FIG. 6 illustrates a diagram of disposing two grounding windings on two phase windings according to the neutral-grounded structure for the delta-connected windings;

FIG. 7 illustrates a diagram of disposing three grounding windings on three phase windings according to the neutral-grounded method for the delta-connected windings of the present invention;

FIG. 8 illustrates a diagram of disposing six grounding windings to the neutral-grounded structure for the delta-connected windings of the present invention;

FIG. 9 illustrates a voltage phasor diagram corresponding to the neutral-grounded structure for the delta-connected windings in FIG. 8;

FIG. 10 illustrates a diagram of disposing a grounding winding group on one phase winding; and

FIG. 11 illustrates a flow chart showing a neutral-grounded method for delta-connected windings.

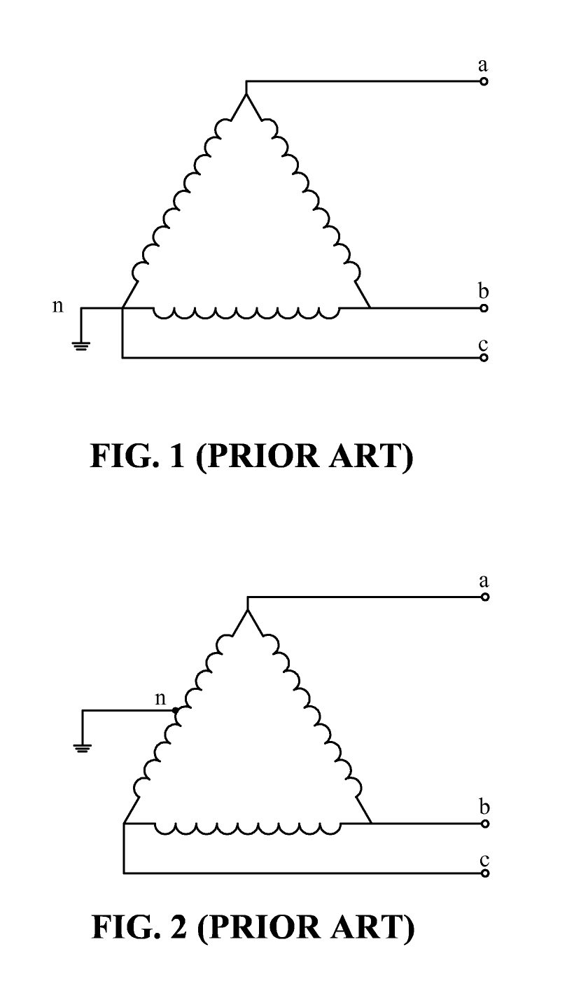

### DETAILED DESCRIPTION OF THE INVENTION

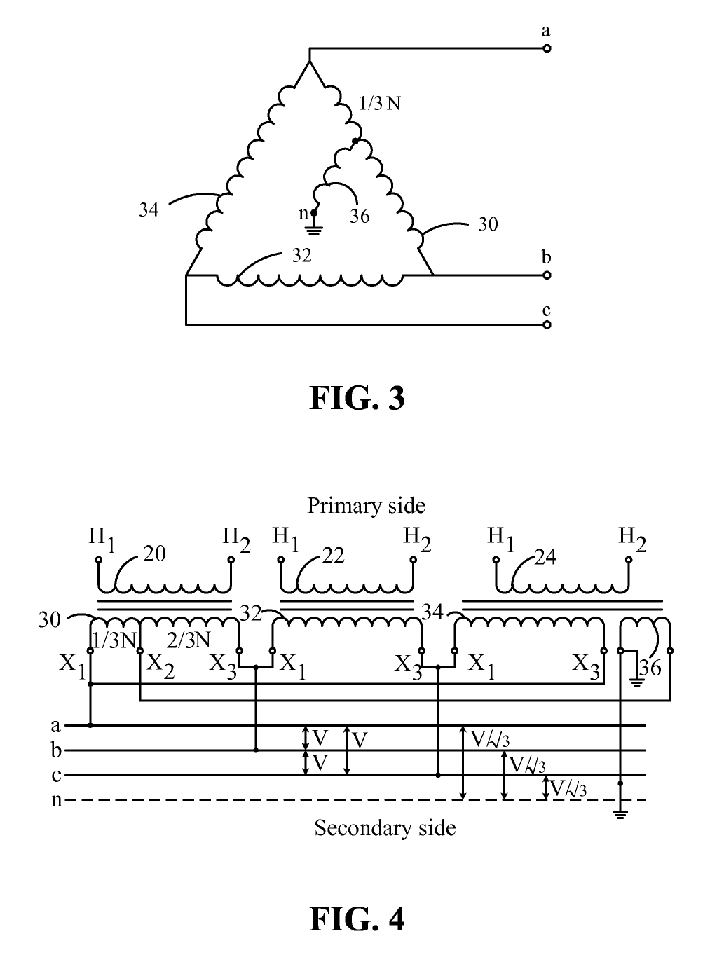

Please refer to FIG. 3. FIG. 3 illustrates a diagram of disposing one grounding winding on one phase winding according to a neutral-grounded structure for delta-connected windings of the present invention. FIG. 4 illustrates a practical circuit according to the neutral-grounded structure in FIG. 3. The practical circuit is a transformer circuit. Primary side of the transformer circuit includes a first phase winding of primary side 20, a second phase winding of primary side 22, and a third phase winding of primary side 24. Connectors H₁, H₂ of each of the phase windings are wye-connected or delta-connected to a three-phase power (not shown). Secondary side of the transformer circuit corresponding to primary side of the transformer circuit includes a first phase winding 30, a second phase winding 32, and a third phase winding 34. The three phase winding 30, 32, 34 are delta-connected. That is, a connector X₃ of the first phase winding 30 is connected to a connector X₁ of the second phase winding 32. A connector X₃ of the second phase winding 32 is connected to a connector X₁ of the third phase winding 34. A connector X₃ of the third phase winding 34 is connected to a connector X₁ of the first phase winding 30. Each of the phase windings in secondary side has N turns. In the neutral-grounded structure of the present invention, a grounding winding 36 is disposed on at least one of the three phase windings 30, 32, 34 in secondary side. In the present embodiment, the grounding winding 36 is disposed on the third phase winding 34. The grounding winding 36 has (⅓)N turns. In order to clarify FIG. 3, the grounding winding 36 is illustrated aligned in parallel to the third phase winding 34. This represents that the grounding winding 36 is disposed on the third phase winding 34. The following figures are similar to FIG. 3 and are not repeated. The grounding winding 36 has a first end and a second end. The first end of the grounding winding 36 is connected to a grounded point which is utilized as a neutral point n. The second end of the grounding winding 36 is connected to a tap of one of the other two phase windings 30, 32. The tap is at (⅓)N turns of one of the other two phase windings 30, 32. The tap is generated by drawing forth from (⅓)N turns of one of the other two phase windings 30, 32. In the present embodiment, the second end of the grounding winding 36 is connected to the tap of (⅓)N turns of the first phase winding 30. The voltage phase of the grounding winding 36 and the voltage of the corresponding phase winding is out of phase. The phase winding corresponding to the grounding winding 36 is the third phase winding 34. In the present embodiment, if a voltage of the third phase winding 34 is Vca, a voltage of the grounding winding 36 must be Vca so that the three phase-to-ground voltages are the same. The above-mentioned term “out of phase” means that a voltage phase displacement between the grounding winding 36 and the third phase winding 34 is 180 degrees.

As shown in FIG. 4, if the voltage between two of the phase lines a, b, c respectively is V, each of the voltages between each of the phase lines a, b, c respectively and the neutral point n is V/√3. That is, each of the phase voltages is V/√3. Accordingly, differences of each of the voltages between the phase lines a, b, c respectively and the grounded point in the conventional grounding methods can be improved. In another aspect, the original phase voltage is V and is now reduced to V/√3. A requirement for dielectric strength of equipment is thus reduced. This represents that the delta-connected windings can apply to higher phase-to-ground voltage than before.

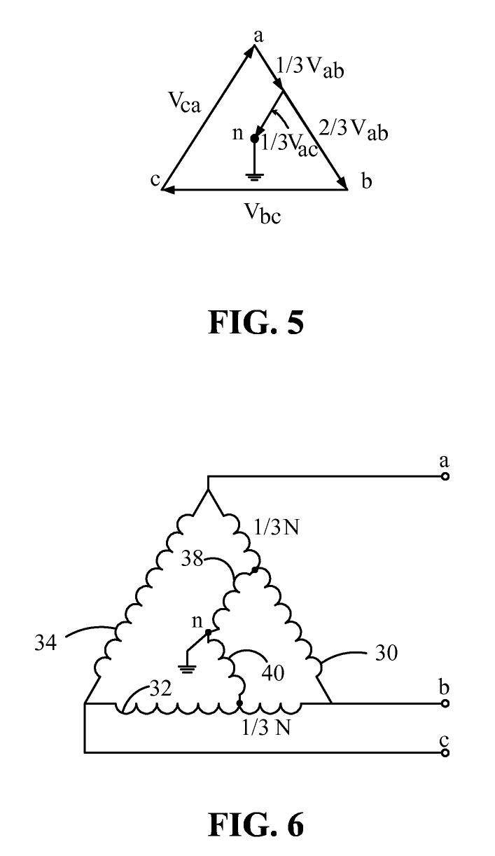

Please refer to FIG. 5. FIG. 5 illustrates a voltage phasor diagram corresponding to the neutral-grounded structure for the delta-connected windings in FIG. 3. When a three-phase power fed to the delta-connected windings is balanced, each of the voltages between each of the phase lines a, b, c respectively and the neutral point is the same. As a result, differences of each of the phase-to-ground voltages in the conventional grounding methods can be improved. It is noted that a voltage phasor (⅓) Vac of the grounding winding 36 is illustrated in parallel to a voltage phasor Vca of the third phase winding 34. This represents that the grounding winding 36 is disposed on the third phase winding 34. The voltage phasor (⅓)Vac of the grounding winding 36 starts from the end of a voltage phasor (⅓)Vca of the first phase winding 30. This represents that the second end of the grounding winding 36 is connected to the tap that is at (⅓)N turns of the first phase winding 30. The vector arrow of the voltage phasor (⅓)Vca is opposite to the vector arrow of the voltage phasor Vac. This represents that the voltage phase displacement between the voltage phasor (⅓)Vca and the voltage phasor Vac is 180 degrees.

For considerations of reliability, the grounding windings can be disposed on two phase windings at the same time. FIG. 6 illustrates a diagram of disposing two grounding windings on two phase windings according to the neutral-grounded structure for the delta-connected windings. In the present embodiment, two grounding windings 38, 40 are disposed on the third phase winding 34 and the first phase winding 30, respectively. Each of the grounding windings 38, 40 has (⅓)N turns. The first end of the grounding winding 38 is connected to the grounded point. The grounded point is a neutral point n. The second end of the grounding winding 38 is connected to a tap at (⅓) number of turns of the first phase winding 30, i.e. (⅓)N turns of the first phase winding 30. The first end of the grounding winding 40 is connected to the grounded point. That is, the first end of the grounding winding 40 is connected to the first end of the grounding winding 38. The second end of the grounding winding 40 is connected to a tap at (⅓)N turns of the second phase winding 32. The grounding windings 38, 40 should have appropriate voltage phases. When a three-phase power fed to the delta-connected windings is balanced, each of the voltages between each of the phase lines a, b, c respectively and the neutral point n is the same. The appropriate voltage phases of the grounding windings 38, 40 are the same as that described in FIG. 3 and omitted herein.

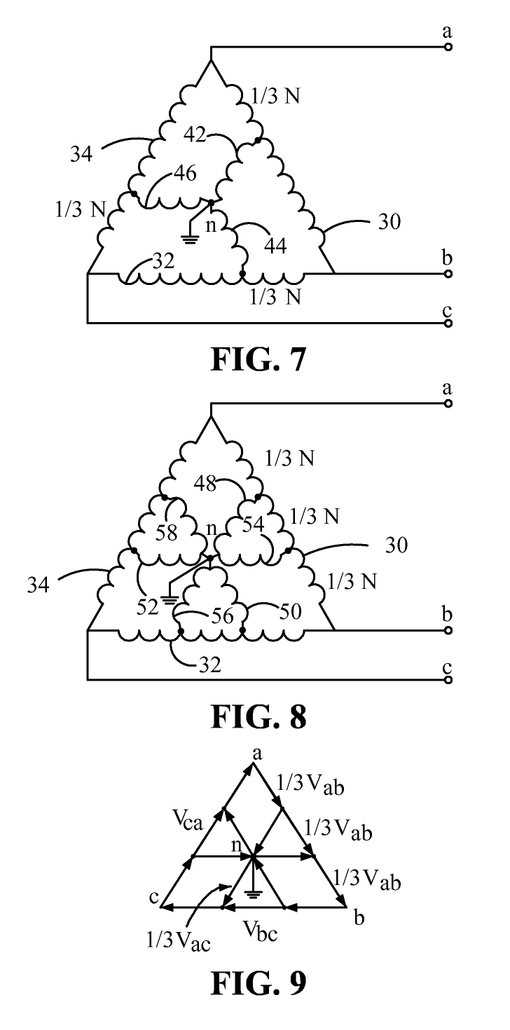

Please refer to FIG. 7. FIG. 7 illustrates a diagram of disposing three grounding windings on three phase windings according to the neutral-grounded method for the delta-connected windings of the present invention. In the present embodiment, three grounding windings 42, 44, 46 are disposed on the phase windings 30, 32, 34, respectively. Each of the grounding windings has (⅓)N turns. The first end of the grounding winding 42, the first end of the grounding winding 44, and the first end of the grounding winding 46 are connected to a grounded point. The grounded point is a neutral point n. The second end of the grounding winding 42 is connected to a tap at (⅓)N turns of the first phase winding 30. The second end of the grounding winding 44 is connected to a tap at (⅓)N turns of the second phase winding 32. The second end of the grounding winding 46 is connected to a tap at (⅓)N turns of the third phase winding 34. The grounding windings 42, 44, 46 should have appropriate voltage phases. When a three-phase power fed to the delta-connected windings is balanced, each of the voltages between each of the phase lines a, b, c respectively and the neutral point n is the same. The appropriate voltage phases of the grounding windings 42, 44, 46 can be obtained by the same manner as that described in FIG. 3 and omitted herein.

Please refer to FIG. 8. FIG. 8 illustrates a diagram of disposing six grounding windings to the neutral-grounded structure for the delta-connected windings of the present invention. In the present invention, six grounding windings can be disposed at most. Numbers of the six grounding windings are 48, 50, 52, 54, 56, 58. Each of the grounding windings 48, 50, 52, 54, 56, 58 has (⅓)N turns. The connections of the grounding windings 48, 50, 52 are the same as the grounding windings 42, 44, 46 shown in FIG. 7. That is, the first end of the grounding winding 48, the first end of the grounding winding 50, and the first end of the grounding winding 52 are connected to a grounded point. The grounded point is a neutral point n. The second end of the grounding winding 48 is connected to a tap at (⅓)N turns of the first phase winding 30. The second end of the grounding winding 50 is connected to a tap at (⅓)N turns of the second phase winding 32. The second end of the grounding winding 52 is connected to a tap at (⅓)N turns of the third phase winding 34. It is noted that the tap at (⅓)N turns is counted from the connector X₁ to the connector X₃ (shown in FIG. 4). In contrast, another tap at (⅓)N turns can be counted from connector X₃ to connector X₁ (shown in FIG. 4). Accordingly, the grounding winding 54 is disposed on another tap of the second phase winding 32. The another tap at (⅓)N turns of the second phase winding 30 is counted from the connector X₃ to the connector X₁ (shown in FIG. 4). The grounding winding 56 is disposed on another tap of the third phase winding 34. The another tap is at (⅓)N turns of the third phase winding 34 is counted from the connector X₃ to the connector X₁ (shown in FIG. 4). The grounding winding 58 is disposed on another tap of the first phase winding 30. The another tap at (⅓)N turns of the first phase winding 30 is counted from the connector X₃ to the connector X₁ (shown in FIG. 4). The first end of the grounding winding 54, the first end of the grounding winding 56, and the first end of the grounding winding 58 are connected to the neutral point n.

In the embodiment in FIG. 3, the second end of the grounding winding 34 is connected to the tap of the first phase winding 30. In another aspect, the second end of the grounding winding 34 can be connected to a tap of the second phase winding 32 (as the grounding winding 56 shown in FIG. 8). The tap at (⅔)N turns of the second phase winding 32 is counted from the connector X₁ to the connector X₃ (shown in FIG. 4). That is, the tap is the same as another tap at (⅓)N turns of the second phase winding 32 which is counted from the connector X₃ to the connector X₁. If the voltage of the third phase winding 34 is Vca, the voltage of the grounding winding 56 must be Vca. The voltage phase displacement between the third phase winding 34 and the grounding winding 56 must be 180 degrees.

The neutral-grounded structure for the delta-connected windings of the present invention can include at least one grounding winding and at most six grounding windings. That is, any one to five of the six grounding windings 48, 50, 52, 54, 56, 58 in FIG. 8 can be removed. Only at least one grounding winding can achieve the objective of the present invention.

Please refer to FIG. 9. FIG. 9 illustrates a voltage phasor diagram corresponding to the neutral-grounded structure for the delta-connected windings in FIG. 8. There are six grounding windings 48, 50, 52, 54, 56, 58 disposed on the phase windings 30, 32, 34 in FIG. 8. When a three-phase voltage fed to the phase windings is balanced, each of the voltages between the phase lines a, b, c respectively and the neutral point n is the same.

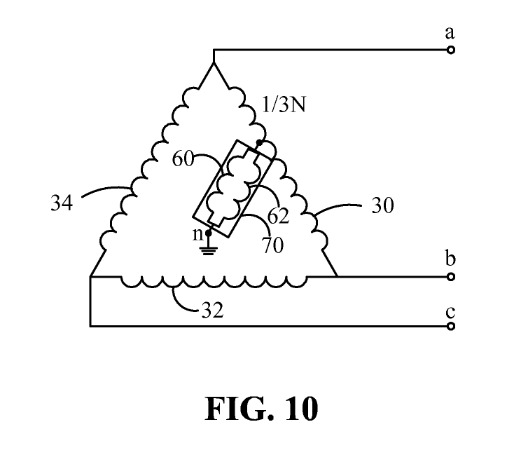

The grounding winding 36 in FIG. 3 can be substituted by a grounding winding group. Please refer to FIG. 10. FIG. 10 illustrates a diagram of disposing a grounding winding group on one phase winding. The first phase winding 30, the second phase winding 32, and the third phase winding 34 are delta-connected. Each of the first phase winding 30, the second phase winding 32, and the third phase winding 34 has a plurality of turns, e.g. N turns. The grounding winding group 70 is disposed on the third phase winding 34. The grounding winding group 70 includes two grounding windings 60, 62 which are connected in parallel. Each of the grounding windings 60, 62 has turns that are (⅓)N turns of the third phase winding 34. The first end of the grounding winding group 70 is connected to a grounded point. The grounded point is a neutral point n. The second end of the grounding winding group 70 is connected to a tap of one of the other two phase windings 30, 32. The tap is at (⅓)N turns of one of the other two phase windings 30, 32. In the present embodiment, the second end of the grounding winding group 70 is connected to a tap of the first phase winding 30. Of course, the second end of the grounding winding group 70 can be connected to a tap at (⅔)N turns of the second phase winding 32. The tap at (⅔)N turns of the second phase winding 32 is counted from the connector X₁ to the connector X₃ (shown in FIG. 4), i.e., at (⅓)N turns counted from the connector X₃ to the connector X₁ (shown in FIG. 4). If the grounding winding group 70 is disposed on the second phase winding 32, the grounding winding group 70 is similar to the grounding winding 56 in FIG. 8. In the present embodiment of FIG. 10, the voltage phase of the grounding winding group 70 and the voltage phase of the third phase winding 34 is out of phase. That is, if the voltage of the third phase winding 34 is Vca, the voltage of the grounding winding group 70 must be Vac so that each of the voltages between each of the phase lines a, b, c respectively and the neutral point n is the same. The above-mentioned term “out of phase” means that a voltage phase displacement between the grounding winding group 70 and the third phase winding 34 is 180 degrees.

The grounding winding group can be disposed on two phase windings or three phase windings as shown in FIG. 6 and FIG. 7. Six grounding winding groups at most can be disposed as shown in FIG. 8. The neutral-grounded structure for the delta-connected windings of the present invention can include at least one grounding winding group and at most six grounding winding groups. That is, any one to five of the six grounding winding groups can be removed. Only at least one grounding winding group can achieve the objective of the present invention.

The grounding winding group is not limited to two grounding winding which are connected in parallel. The grounding winding group can include three or more grounding windings which are connected in parallel.

When one wire is connected to the neutral point n and grounded in one of the above-mentioned embodiments, the first phase winding, the second phase winding, the third phase winding, and the wire are connected as three-phase four-wire delta-connected windings. When no wire is connected to the neutral point n in one of the above-mentioned embodiments, the first phase winding, the second phase winding, and the third phase winding are connected as three-phase three-wire delta-connected windings.

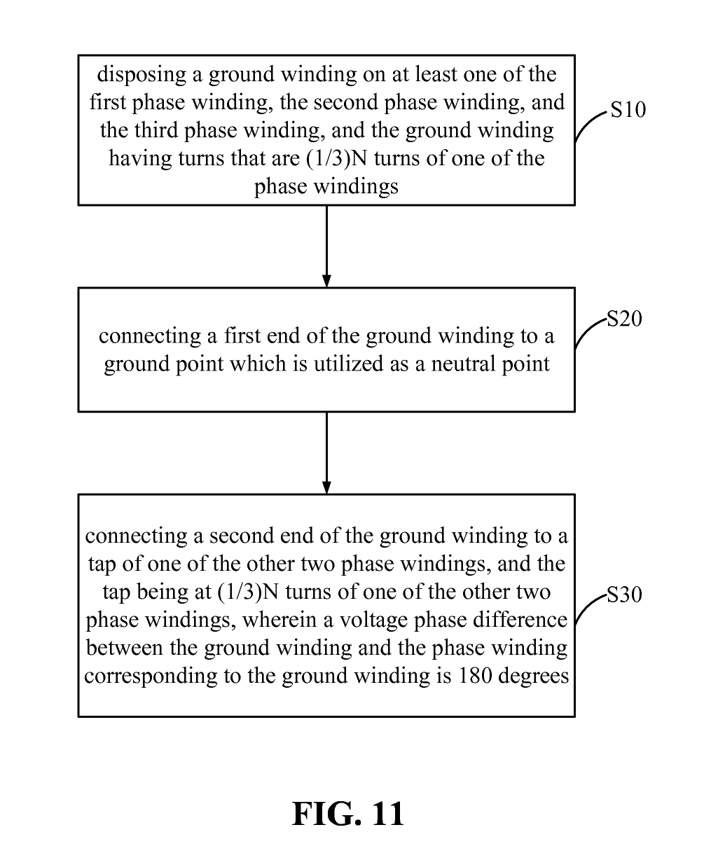

Please refer to FIG. 11. FIG. 11 illustrates a flow chart showing a neutral-grounded method for delta-connected windings. The delta-connected windings include a first phase winding, a second phase winding, and a third phase winding. Each of the first phase winding, the second phase winding, and the third phase winding has a plurality of turns, e.g. N turns. The neutral-grounded method includes the following steps. In Step 10, a grounding winding is disposed on at least one of the first phase winding, the second phase winding, and the third phase winding. The grounding winding has turns that are (⅓)N turns of each of the phase windings. In Step 20, the first end of the grounding winding is connected a grounded point. The grounded point is a neutral point n. In Step 30, the second end of the grounding winding is connected to a tap of one of the other two phase winding. The tap is at (⅓)N turns of one of the other two phase windings. The voltage phase displacement between the grounding winding and the phase winding corresponding to the grounding winding is 180 degrees.

According to the neutral-grounded structure for the delta-connected windings and method thereof, each of the first phase winding, the second phase winding, and the third phase winding is a double-winding or a multi-winding.

Advantages of the present invention are described as following. The first, when a three-phase power fed to the delta-connected windings is balanced, each of the voltages between the phase lines a, b, c respectively and the neutral point n is the same. As a result, differences of each of the three phase-to-ground in the conventional grounding methods can be improved. The second, after the grounding winding is disposed, dielectric strength of the delta-connected windings can be increased. Accordingly, the delta-connected windings have advantages of both the delta-connected windings and the wye-connected windings.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A neutral-grounded structure for delta-connected windings, the delta-connected windings comprising a first phase winding, a second phase winding, and a third phase winding, each of the first phase winding, the second phase winding, and the third phase winding having N turns, the neutral-grounded structure comprising:
a grounding winding disposed on at least one of the first phase winding, the second phase winding, and the third phase winding, the grounding winding having turns that are (⅓)N turns of one of the phase windings, wherein the first end of the grounding winding is connected to the grounded point which is utilized as a neutral point, the second end of the grounding winding is connected to a tap of one of the other two phase windings, the tap is at (⅓)N turns of one of the other two phase windings, and the voltage phase displacement between the grounding winding and the corresponding phase winding is 180 degrees.

2. The neutral-grounded structure for delta-connected windings of claim 1, wherein each of the first phase winding, the second phase winding, and the third phase winding is a double-winding.

3. The neutral-grounded structure for delta-connected windings of claim 1, wherein each of the first phase winding, the second phase winding, and the third phase winding is a multi-winding.

4. The neutral-grounded structure for delta-connected windings of claim 1, wherein the tap is generated by drawing forth from (⅓)N turns of one of the other two phase windings.

5. The neutral-grounded structure for delta-connected windings of claim 1, wherein one wire is connected to the neutral point, and the first phase winding, the second phase winding, the third phase winding, and the wire are connected as three-phase four-wire delta-connected windings.

6. The neutral-grounded structure for delta-connected windings of claim 1, wherein no wire is connected to the neutral point, and the first phase winding, the second phase winding, and the third phase winding are connected as three-phase three-wire delta-connected windings.

7. A neutral-grounded structure for delta-connected windings, the delta-connected windings comprising a first phase winding, a second phase winding, and a third phase winding, each of the first phase winding, the second phase winding, and the third phase winding having N turns, the neutral-grounded structure comprising:
a grounding winding group disposed on at least one of the first phase winding, the second phase winding, and the third phase winding, the grounding winding group comprising at least two grounding windings connected in parallel, each of the grounding windings having turns that are (⅓)N turns of one of the phase windings, wherein the first end of the grounding winding group is connected to a grounded point which is utilized as a neutral point, the second end of the grounding winding group is connected to a tap of one of the other two phase windings, the tap is at (⅓)N turns of one of the other two phase windings, and the voltage phase displacement between the grounding winding group and the phase winding corresponding to the grounding winding is 180 degrees.

8. The neutral-grounded structure for delta-connected windings of claim 7, wherein each of the first phase winding, the second phase winding, and the third phase winding is a double-winding.

9. The neutral-grounded structure for delta-connected windings of claim 7, wherein each of the first phase winding, the second phase winding, and the third phase winding is a multi-winding.

10. The neutral-grounded structure for delta-connected windings of claim 7, wherein the tap is generated by drawing forth from (⅓)N turns of one of the other two phase windings.

11. The neutral-grounded structure for delta-connected windings of claim 7, wherein one wire is connected to the neutral point, and the first phase winding, the second phase winding, the third phase winding, and the wire are connected as three-phase four-wire delta-connected windings.

12. The neutral-grounded structure for delta-connected windings of claim 7, wherein no wire is connected to the neutral point, and the first phase winding, the second phase winding, and the third phase winding are connected as three-phase three-wire delta-connected windings.

13. A neutral-grounded method for delta-connected windings, the delta-connected windings comprising a first phase winding, a second phase winding, and a third phase winding, each of the first phase winding, the second phase winding, and the third phase winding having N turns, the neutral-grounded method comprising:
disposing a grounding winding on at least one of the first phase winding, the second phase winding, and the third phase winding, and the grounding winding having turns that are (⅓)N turns of one of the phase windings;
connecting the first end of the grounding winding to a grounded point which is utilized as a neutral point; and
connecting the second end of the grounding winding to a tap of one of the other two phase windings, and the tap being at (⅓)N turns of one of the other two phase windings, wherein the voltage phase displacement between the grounding winding and the phase winding corresponding to the grounding winding is 180 degrees.

14. The neutral-grounded structure for delta-connected windings of claim 13, wherein each of the first phase winding, the second phase winding, and the third phase winding is a double-winding.

15. The neutral-grounded structure for delta-connected windings of claim 13, wherein each of the first phase winding, the second phase winding, and the third phase winding is a multi-winding

16. The neutral-grounded method for delta-connected windings of claim 13, wherein the tap is generated by drawing forth from (⅓)N turns of one of the other two phase windings.

17. The neutral-grounded method for delta-connected windings of claim 13, wherein one wire is connected to the neutral point, and the first phase winding, the second phase winding, the third phase winding, and the wire are connected as three-phase four-wire delta-connected windings.

18. The neutral-grounded method for delta-connected windings of claim 13, wherein no wire is connected to the neutral point, and the first phase winding, the second phase winding, and the third phase winding are connected as three-phase three-wire delta-connected windings.
